(19) United States
(12) Patent Application Publication
(10) Pub. No.: US 2013/0032038 A1
(43) Pub. Date: Feb. 7, 2013

(54) COLD AND HOT BLENDER

(71) Applicants: Hei-Wang LEE, Tainan City (TW); Chun-cheng Sung, Tainan City (TW)

(72) Inventors: Hei-Wang LEE, Tainan City (TW); Chun-cheng Sung, Tainan City (TW)

(73) Assignee: TSANN KUEN (ZHANG ZHOU) ENTERPRISE CO., LTD., Zhangzhou (CN)

(21) Appl. No.: 13/564,125

(22) Filed: Aug. 1, 2012

(30) Foreign Application Priority Data
Aug. 2, 2011 (CN) 201120278801.6

(51) Int. Cl. A23L 1/00

(52) U.S. Cl. 99/348

(57) ABSTRACT

A cold and hot blender has a body, a pulp container, a cup lid, a blade group and a motor; a boiler generating the steam is arranged in the body; steam outlet of boiler is communicated with pulp container; a boiler switch is arranged on the body. The food material in the pulp container is processed into cold juice when the motor is started. The food material in the pulp container is processed into hot drink by the rotary blade group and steam generated by the boiler when the motor and the boiler are started. The food material in the pulp container is steamed or boiled by steam when only the boiler is started. The boiler is started and the food material in the pulp container is steamed. Then the food material is processed into hot puree when the boiler stops and the motor is started.

### FIELD OF THE INVENTION

The present invention relates to a domestic food processing equipment, and more particularly to a domestic food processing equipment with the function of cutting up and stirring.

### BACKGROUND OF THE INVENTION

General blender comprises: the body, the pulp container, the cup lid, the blade group, the motor and the clutch. The operation interface is arranged on the outer surface of the body as a base, and the motor is fixed in the body. The clutch is composed of the upper clutch part and the lower clutch part, the upper clutch part is arranged at the outside of the bottom of the pulp container, and is connected to the shaft of the blade group in the pulp container; the lower clutch part is connected to the shaft of the motor in the body. During the using process, the food material such as melon is put in the pulp container, and the cup lid is buckled at the opening of the pulp container. The pulp container is arranged at the opening above the body. The upper clutch part under the pulp container is meshed with the lower clutch part at the motor in the body. The rotation of the motor is operated through the operation interface of the body, the rotation of the blade group is driven by the motor through the clutch, and the food material is processed into the juice. And then, the pulp container is lifted up, and the upper clutch part of the clutch is separated from the lower clutch part, and the pulp container is separated from the body. People can freely open the cup lid, pour the juice and clean the blade group and the pulp container. But the blender at the prior art can only process the food material at room temperature into the juice at room temperature, external heating is needed when the users need hot drink; when hot and infant-needed vegetable and meat paste is needed, the blender at the prior art can only cut up and stir the fruit, the vegetable and the meat, the cooking is achieved by other equipment; too many equipments are needed, and the processing procedure is complicated.

### SUMMARY OF THE INVENTION

The object of the present invention is to offer a cold and hot blender that can make cold drink, hot drink and hot food paste product independently.

The technical proposal of the present invention is: Cold and hot blender, which comprises the body, the pulp container, the cup lid, the blade group and the motor; a boiler generating the steam is arranged in the body; the steam outlet of the boiler is communicated with the pulp container; a boiler switch used for controlling the power of the heater of the boiler is arranged on the body.

The operation methods are: 1 the food material in the pulp container is processed into the cold juice at room temperature by the rotary blade group when only the motor is started; 2 the food material in the pulp container is processed into hot drink by the rotary blade group and the steam when the motor and the boiler are started; 3 The food material in the pulp container is steamed or boiled by the steam when only the boiler is started; 4 the boiler is started first, and the food material in the pulp container is steamed or boiled by the steam; and then the food material in the pulp container is processed into hot puree or hot food paste product when the boiler is stop and the motor is started.

In a preferred embodiment, the body can be separated from the pulp container: a clutch is arranged between the body and the pulp container;

a pipe socket is arranged in the body and communicated with the steam outlet of the boiler; a check valve and a pipe plug are arranged at the bottom of the pulp container, and the outlet of the check valve is arranged at the inside of the pulp container, and the inlet of the check valve is arranged at the outside of the pulp container and communicated with the pipe plug; the pipe plug on the pulp container is inserted in the pipe socket on the body. Through this kind of structure design, the pulp container can be quickly mounted on the body, and the steam can be transmitted into the pulp container without leaking; or the pulp container can be quickly separated from the body, and the substance in the pulp container will not be leaked.

A filter is arranged at the outlet of the check valve. The food material in the pulp container is stopped from getting close to the outlet of the check valve by the filter, and the outlet of the check valve will not be blocked and always at good and normal working state.

A rubber liner tube and a duct connector are sleeved in the pipe socket of the body, and the duct connector is communicated with the steam outlet of the boiler through the heat-resistant duct; the liner pipe is arranged between the pipe socket and the duct connector, and the upper end surface of the liner tube is against the lower end surface of the pipe plug, and the pipe plug can couple with the pipe socket hermetically. This kind of pipe socket can strictly prevent the leaking of the steam.

A water tank and a water pump are arranged in the body, and the water pump is arranged between the outlet of the water tank and the inlet of the boiler; the water pump is controlled by the control interface on the body. This kind of structure is convenient for controlling the quantity of steam and supplying water into the boiler.

A controller controlling the rotary speed of the motor is arranged on the body, and the controller is connected in the electric circuit between the motor and the power resource. The rotary speed of the motor is adjusted by the controller to adapt special demands when dealing with the food with different smoothies (such as liquid or mushy), and the changing of the blade group is not needed; it is convenient for the users to process the food with different smoothies.

Steam outlet holes are opened on the cup clip. The steam can flow smoothly out of the pulp container, and the normal path that the steam flows from bottom to top and outwards is formed in the pulp container.

Stops opened one-way is arranged at the inside of the steam outlet holes of the cup clip, and the opening direction of the stops are same as the rotary direction of the blade group in the pulp container. When the liquid food material is processed, the stops on the cup clip prevent liquid food material from overflowing out of the pulp container from the steam outlet hole, and at the same time, the steam is guaranteed to flow smoothly out of the pulp container, and the normal path that the steam flows from bottom to top and outwards is formed in the pulp container. The structure is simple and the effect is remarkable.

The cold and hot blender in the present invention uses steam for steaming, boiling or simply heating the food material in the pulp container, and can process cold or hot food. Cold is aimed at fresh juice, fruit smoothie. Hot is aimed at vegetable puree and meat puree. Two or more than two kinds of utensils are needed when making puree or infant-needed vegetable and meat paste, and the operation procedure comprises heating, boiling the food material and then cutting up and stirring. The cold and hot blender in the present invention can simplify the complicated operation procedure, and becomes multi-purpose food regulating assistant. Proved by experiment, most of nutrition is kept in the food made by steam, and the puree made by steam is authentic. The steaming process can keep the nutrition of food furthest. The nutrition and the delicacy will not relish. It is light for nourishing the stomach and cannot get inflamed when having the steamed food, and there are no animal oil and less cholesterol and carcinogens in the steamed food.

The biggest advantage of the cold and hot blender in the present invention reflects the care for people. It is not easy to get inflamed when having boiled and steamed food; most of the modern people over works with fire excess from yin deficiency, the steaming process gets hot through water with yin and yang in all aid, it can get inflamed when having steamed food. The ladys having steamed food are more beautiful without pimple, and the stomach of the gentlemen having steamed food is healthier for low simulation from steamed food.

The nutrition of steamed food is rich: the steaming process can keep the delicacy and the nutrition of food furthest, and prevent the food material from uneven heating, destroying the active ingredient and producing harmful substance during excessive decocting and frying process! For example, there is no radical in the steamed food. The radical is produced in the body when the food is decocted or fried at high temperature and the cooking oil is oxidized, and the radical can accelerate the aging of human body and aggravate the happening of various cardiovascular diseases.

The steamed food is sanitary: the steaming process is called moist heat sterilization in medical. During the steaming process, the tableware is sterilized by steam, and the secondary pollution is avoided!

### BRIEF DESCRIPTION OF THE DRAWINGS

FIG. 1 shows the frontal structure diagram of one embodiment of the cold and hot blender in the present invention;

FIG. 2 shows the partial sectional structure diagram of the embodiment in FIG. 1;

FIG. 3 shows the structure diagram of the inside of the cup lid in the embodiment in FIG. 1;

FIG. 4 shows the partial sectional structure diagram of cup clip in the embodiment in FIG. 1.

### DESCRIPTION OF THE PREFERRED EMBODIMENTS

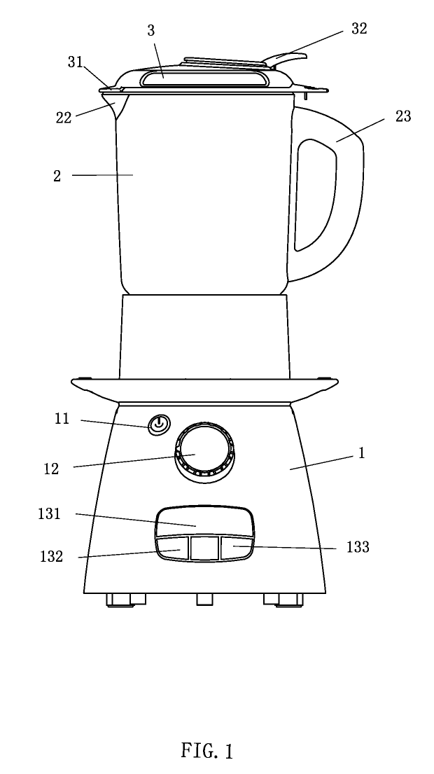

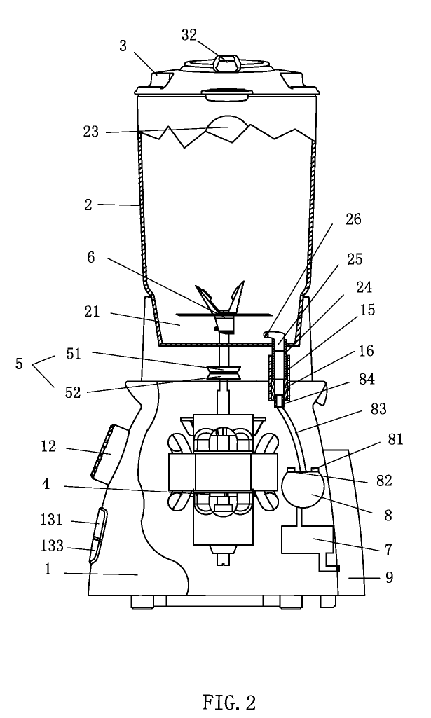

As shown in FIGS. 1 and 2, the structure of one preferred embodiment of the cold and hot blender in the present invention comprises: the body 1, the power switch 11, the controller 12, the time switch 131, the pump switch 132, the boiler switch 133, the pulp container 2, the cup lid 3, the motor 4, the clutch 5, the blade group 6, the water pump 7, the boiler 8, the water tank 9, the pipe socket 16, the pipe plug, the check valve 25, the filter 26 and so on.

The body 1 acts as a base, the operation interface is arranged on the outer surface of the body, which comprises the power switch 11, the controller 12, the time switch 131, the pump switch 132 and the boiler switch 133. Of course, this kind of operation interface can be achieved by the corresponding switch button at the prior art, every button of the operation interface sends signal to the controller with microcomputer chip, and the corresponding function is achieved by the controller. The motor 4, the water tank 9, the water pump 7, the boiler 8 and the pipe socket 16 are fixedly mounted in the body 1. The water pump 7 is arranged between the outlet of the water tank 9 and the inlet of the boiler 8, a rubber liner tube 16 and a duct connector 84 are sleeved in the pipe socket 15, and the liner tube 16 is arranged between the pipe socket 15 and the duct connector 84. The duct connector 84 is communicated with the steam outlet of the boiler 8 through the heat-resistant duct 83. The power switch 11 controls the connection of the outer power resource. The time switch 131, the pump switch 132 and the boiler switch 133 are respectively connected in the electric circuit between the motor 4, the motor of the water pump 7, the heater of the boiler 8 and the output port of the power switch 11, and respectively control their on or off. A temperature controller 81 and a overheat protector 82 are arranged on the heater of the boiler 8, the time controller 81 can momently cut off the power of the heater when water temperature in the boiler 8 gets the provided value; the overheat protector can totally cut off the power of the complete machine when the temperature controller 81 is at abnormal or disable model. The temperature controller 81 can be the mechanical thermostat or the electronic thermostat at the prior art. The overheat protector 82 can be the thermal fuse.

The blade group 6, the pipe plug 24 and the check valve 25 are fixedly mounted on the bottom 21 of the pulp container 2. The outlet of the check valve 25 is at the inside of the pulp container 2, the inlet of the check valve 25 is at the outside of the pulp container 2 and is communicated with the pipe plug 24 extended outward, the filter 26 is arranged at the outlet of the check valve 25. The filter 26 can be the filter net made of metal wire. An ultra short draining mouth 22 is arranged at the upper opening end of the pulp container 2; the handle 23 is arranged at the periphery of the pulp container 2.

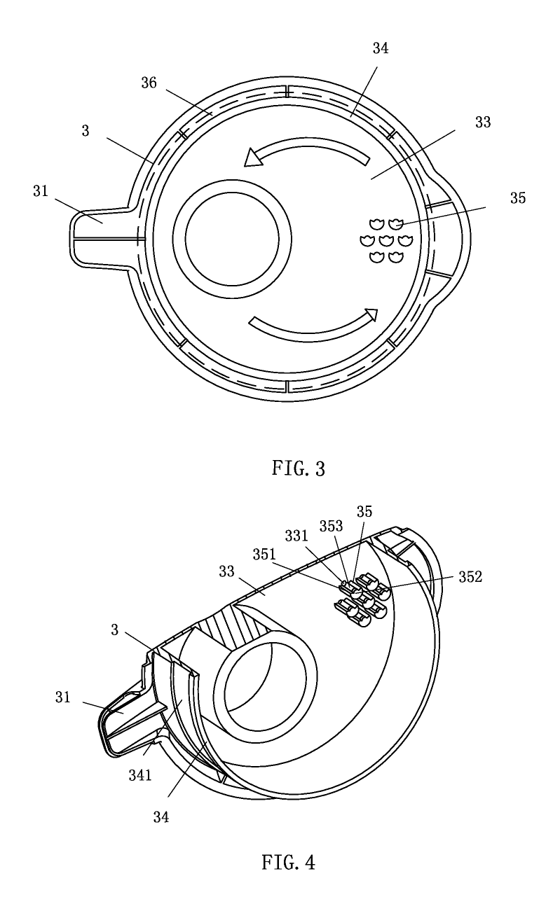

The structure of the cup clip 3 is shown in FIGS. 1, 2, 3 and 4. The upper half of the cup clip 3 is an up-side-down disc, and one side of its edge side is extended outward to form the separation slice 31 used for covering the draining mouth 22 of the pulp container 2. A short handle 32 is arranged on the top plate 33 of the cup clip 3. The inside of the top plate 33 of the cup clip 3 is extended downwards to form the cylindrical side wall 34, and a circular groove 341 is opened at the lower part of the outer surrounding surface of the side wall 34 for mounting the sealing ring 36 shown by the dotted line in FIG. 3. A plurality of the steam outlet holes 331 is open on the top plate 33 of the cup clip 3, the stops 35 extended downwards and one-way opened are arranged on the lower side of the top plate 33 of the cup clip 3 (namely the inside of the steam outlet hole 331) corresponding to each steam outlet hole 331, and each stop 35 is composed of a half-tubular upright 351 with opening side and a fan-shaped end plate 352, the corresponding steam outlet hole 331 is encircled at the upper end of the upright 351, the end plate 352 is connected to the lower end of the upright 351; the steam outlet hole 331 is directly facing the opening 353 of the upright 351 and the middle projecting part of the end plate 352. The direction of the opening 353 of the upright 351 is same as the rotary direction of the blade group 6 in the pulp container 2, which is shown as the two arrows in FIG. 3.

The clutch 5 is composed of the upper clutch part 51 and the lower clutch part 52, the upper clutch part 51 is arranged at the outside of the bottom of the pulp container 2 and connected to the shaft of the blade group 6 in the pulp container 2. The lower clutch part 52 is connected to the shaft of the motor 4 in the body 1.

During the using process, the food material (such as melon) is put in the pulp container 2, and then the cup clip 3 is buckled at the opening of the pulp container 2. The draining mouth 22 of the pulp container 2 and the upper end of the pulp container 2 are sealed by the sealing ring 36 of the cup clip 3. The pulp container 2 is placed at the upper opening of the body 1, and the pipe plug 24 of the pulp container 2is inserted in the pipe socket 15 of the body 1, and the upper end surface of the liner tube 16 is against the lower end surface of the pipe plug 24, so that the pipe plug 24 can couple with the pipe socket 15 hermetically. The upper clutch part 51 under the pulp container 2 is meshed with the lower clutch part 52 of the motor 4 in the body 1.

There are four specific operation methods of the present embodiment:

1 The food material in the pulp container is processed into the cold juice at room temperature. The motor 4 is operated to run at provided rotation speed through the power switch. 11, the controller 12 and the time switch 131 on the body 1, the rotation of the blade group 6 is driven by the motor 4 through the clutch 5 to process the food material into fruit juice. Then, the pulp container is lifted up to separate the upper clutch part 51 and the lower clutch part 52 of the clutch 5, the pulp container 2 is separated from the body 1. People can freely open the cup clip 3, pour the juice and clean the pulp container 2 and the blade group 6 in the pulp container 2.

2 The food material in the pulp container is processed into hot drink. The power switch 11 and the pump switch 132 in the body 1 is on, and the water in the water tank 9 is pump into the boiler 8; then the boiler switch 133 is turn on and supplies power to the heater of the boiler 8; the controller 12 is well adjusted and the time switch 131 is turn on at the same time, the motor 4 is operated to run at provided rotation speed, the rotation of the blade group 6 is driven by the motor 4 through the clutch 5 to process the food material into fruit juice; at the same time, the fruit juice in the pulp container 2 is heated into hot drink by the steam from the boiler 8. When the liquid food material is processed, each stop 35 on the cup clip 3 prevent liquid food material from overflowing out of the pulp container 2 the corresponding steam outlet hole 331, and at the same time, the steam is guaranteed to flow smoothly out of the pulp container 2, and the normal path that the steam flows from bottom to top and outwards is formed in the pulp container 2. The steam from the boiler 8 is allowed to enter the pulp container 2 by the check valve 25 on the bottom of the pulp container 2, and the liquid in the pulp container 2 is stopped from flowing outwards when no steam enters, the food material in the pulp container 2 is stopped from getting close to the outlet of the check valve 2 by the filter 26 on the check valve 25, and the outlet of the check valve 25 will not be blocked and always at good and normal working state.

3 The food material in the pulp container is steamed or boiled. The power switch 11 and the pump switch 132 in on the body 1, and the water in the water tank 9 is pump into the boiler 8; then the boiler switch 133 is turn on and supplies power to the heater of the boiler 8; then the food material in the pulp container is steamed or boded by the steam from the boiler 8. If water is put into the pulp container 2 beforehand, the water in the pulp container 2 can be heated and the food material in the pulp container 2 can be steamed or boiled by thy steam entering the pulp container 2. During heath g process for the food material in the pulp container 2, small part of the steam ma be condensed into liquid state and is heated by the steam subsequent entering the boiler 8, so that the steaming and the boiling can process at the same time.

4 The food material in the pulp container is processed into hot puree or hot food paste product. The power switch 11 and the pump switch 132 in on the body 1, and the water in the water tank 9 is pump into the boiler 8; then the boiler h 133 is turn on and supplies power to the heater of the boiler 8; then the food material in the pulp container is steamed or boiled by the steam from the boiler 8; after the food material is well done, the boiler switch 133 is turn off and stops supplying power to the heater of the boiler 8. The motor 4 is operated to run at provided rotation speed through the power switch 11 and the time switch 131 on the body 1, and the rotation of the blade group 6 is driven by the motor 4 through the clutch 5 to process the food material into hot puree or hot food paste product. To satisfy special demands for foods with different smoothies (such as liquid or pureey), the rotary speed of the motor 4 can be changed to adapt processing, demands by adjusting the controller 12 without replacing the blade group 6.

The invention has been described with reference to the preferred embodiments mentioned above; therefore it cannot limit the reference implementation of the invention. It is obvious to a person skilled in the art that structural modification and changes can be carried out without leaving the scope of the claims hereinafter and the description above.

What is claimed is:

1. Cold and hot blender comprising: a body, a pulp container, a cup lid, a blade group and a motor; wherein, a boiler generating the steam is arranged in the body; steam outlet of the boiler is communicated with the pulp container; a boiler switch used for controlling the power of the heater of the boiler is arranged on the body.

2. Cold and hot blender according to claim 1, wherein, a clutch is arranged between the body and the pulp container; a pipe socket is arranged in the body and communicated with the steam outlet of the boiler; a check valve and a pipe plug are arranged at the bottom of the pulp container, and the outlet of the check valve is arranged at the inside of the pulp container, and the inlet of the check valve is arranged at the outside of the pulp container and communicated with the pipe plug; the pipe plug on the pulp container is inserted in the pipe socket on the body.

3. Cold and hot blender according to claim 2, wherein, a filter is arranged at the outlet of the check valve.

4. Cold and hot blender according to claim 2, wherein, a rubber liner tube and a duct connector are sleeved in the pipe socket of the body, and the duct connector is communicated with the steam outlet of the boiler through the heat-resistant duct; the liner pipe is arranged between the pipe socket and the duct connector, and the upper end surface of the liner tube is against the lower end surface of the pipe plug, and the pipe plug can couple with the pipe socket hermetically.

5. Cold and hot blender according to claim 1, wherein, a water tank and a water pump are arranged in the body, and the water pump is arranged between the outlet of the water tank and the inlet of the boiler; a pump switch used for controlling the water pump is arranged on the body.

6. Cold and hot blender according to claim 1, wherein, a controller controlling the rotary speed of the motor is arranged on the body, and the controller is connected in the electric circuit between the motor and the power resource.

7. Cold and hot blender according to claim 1, wherein, steam outlet holes are opened on the cup clip.

8. Cold and hot blender according to claim 7, wherein, stops opened one-way is arranged at the inside of the steam outlet holes of the cup clip, and the opening direction of the stops are same as the rotary direction of the blade group in the pulp container.

9. Cold and hot blender according to claim 2, wherein, a controller controlling the rotary speed of the motor is arranged on the body, and the controller is connected in the electric circuit between the motor and the power resource.

10. Cold and hot blender according to claim 3, wherein, a controller controlling the rotary speed of the motor is arranged on the body, and the controller is connected in the electric circuit between the motor and the power resource.

11. Cold and hot blender according to claim 4, wherein, a controller controlling the rotary speed of the motor is arranged on the body, and the controller is connected in the electric circuit between the motor and the power resource.

12. Cold and hot blender according to claim 5, wherein, a controller controlling the rotary speed of the motor is arranged on the body, and the controller is connected in the electric circuit between the motor and the power resource.

13. Cold and hot blender according to claim 2, wherein, steam outlet holes are opened on the cup clip.

14. Cold and hot blender according to claim 3, wherein, steam outlet holes are opened on the cup clip.

15. Cold and hot blender according to claim 4, wherein, steam outlet holes are opened on the cup clip.

16. Cold and hot blender according to claim 5, wherein, steam outlet holes are opened on the cup clip.

17. Cold and hot blender according to claim 13, wherein, stops opened one-way is arranged at the inside of the steam outlet holes of the cup clip, and the opening direction of the stops are same as the rotary direction of the blade group in the pulp container.

18. Cold and hot blender according to claim 14, wherein, stops opened one-way is arranged at the inside of the steam outlet holes of the cup clip, and the opening direction of the stops are same as the rotary direction of the blade group in the pulp container.

19. Cold and hot blender according to claim 15, wherein, stops opened one-way is arranged at the inside of the steam outlet holes of the cup clip, and the opening direction of the stops are same as the rotary direction of the blade group in the pulp container.

20. Cold and hot blender according to claim 16, wherein, stops opened one-way is arranged at the inside of the steam outlet holes of the cup clip, and the opening direction of the stops are same as the rotary direction of the blade group in the pulp container.
